(19) United States
(12) Patent Application Publication
(10) Pub. No.: US 2025/0203383 A1
(43) Pub. Date: Jun. 19, 2025

(54) TRANSMISSIONS ON MIXED DYNAMIC FREQUENCY SELECTION CHANNELS DURING CHANNEL AVAILABILITY CHECK

(71) Applicant: QUALCOMM Incorporated, San Diego, CA (US)

(72) Inventor: Rohan DUTTA, Chennai (IN)

(21) Appl. No.: 18/849,944

(22) PCT Filed: Jul. 27, 2022
(86) PCT No.: PCT/US2022/038565

§ 371 Date: Sep. 23, 2024

(30) Foreign Application Priority Data
Jun. 8, 2022 (IN) 202241032748

(51) Int. Cl. H04W 16/14

(52) U.S. Cl. CPC H04W 16/14

(57) ABSTRACT

Methods, systems, and devices for wireless communications are described. An access point (AP) may update a bitmap (e.g., an extremely high throughput (EHT) operations (Ops) information element (IE) disabled subchannel bitmap) that indicates which channels of a band are available and unavailable. In some examples, the AP may update the bitmap during a channel availability check (CAC) based on whether various channels are DFS channels or non-DFS channels. During the CAC, the AP may transmit beacons to one or more stations (STAs) on the available non-DFS channels (e.g., instead of waiting until after the CAC to perform any beaconing).

### CROSS REFERENCE

The present Application is a 371 national stage filing of International PCT Application No. PCT/US2022/038565 by Dutta., entitled “TRANSMISSIONS ON MIXED DYNAMIC FREQUENCY SELECTION CHANNELS DURING CHANNEL AVAILABILITY CHECK,” filed Jul. 27, 2022; and claims priority to Indian patent application Ser. No. 202241032748 by Dutta., entitled “TRANSMISSIONS ON MIXED DYNAMIC FREQUENCY SELECTION CHANNELS DURING CHANNEL AVAILABILITY CHECK,” filed Jun. 8, 2022, each of which is assigned to the assignee hereof, and each of which is expressly incorporated by reference in its entirety herein.

### BACKGROUND

The following relates to wireless communications, including transmissions on mixed dynamic frequency selection channels during a channel availability check.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include access points (APs) that may communicate with one or more stations (STAs) or mobile devices. The AP(s) may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL) communications. The DL (or forward link) may refer to the communication link from the AP to the station, and the UL (or reverse link) may refer to the communication link from the station to the AP.

### SUMMARY

The described techniques relate to improved methods, systems, devices, or apparatuses that support transmissions on mixed dynamic frequency selection (DFS) channels during a channel availability check. Generally, an access point (AP) may update a bitmap (e.g., an extremely high throughput (EHT) operations (Ops) information element (IE) disabled subchannel bitmap) that indicates which channels of a band are available and unavailable. In some examples, the AP may update the bitmap during a channel availability check (CAC) based on whether various channels are DFS channels or non-DFS channels. During the CAC, the AP may transmit beacons to one or more stations (STAs) on the available non-DFS channels (e.g., instead of waiting until after the CAC to perform any beaconing).

A method for wireless communications at an access point is described. The method may include identifying that a communications band includes one or more first channels of a first dynamic frequency selection type and one or more second channels of a second dynamic frequency selection type, performing a channel availability check procedure to determine if radar is being used on one of the one or more first channels, and transmitting, to a station during the channel availability check procedure, one or more beacons on at least one of the one or more second channels.

An apparatus for wireless communications at an access point is described. The apparatus may include a processor, memory coupled with the processor, and instructions stored in the memory. The instructions may be executable by the processor to cause the apparatus to identify that a communications band includes one or more first channels of a first dynamic frequency selection type and one or more second channels of a second dynamic frequency selection type, perform a channel availability check procedure to determine if radar is being used on one of the one or more first channels, and transmit, to a station during the channel availability check procedure, one or more beacons on at least one of the one or more second channels.

Another apparatus for wireless communications at an access point is described. The apparatus may include means for identifying that a communications band includes one or more first channels of a first dynamic frequency selection type and one or more second channels of a second dynamic frequency selection type, means for performing a channel availability check procedure to determine if radar is being used on one of the one or more first channels, and means for transmitting, to a station during the channel availability check procedure, one or more beacons on at least one of the one or more second channels.

A non-transitory computer-readable medium storing code for wireless communications at an access point is described. The code may include instructions executable by a processor to identify that a communications band includes one or more first channels of a first dynamic frequency selection type and one or more second channels of a second dynamic frequency selection type, perform a channel availability check procedure to determine if radar is being used on one of the one or more first channels, and transmit, to a station during the channel availability check procedure, one or more beacons on at least one of the one or more second channels.

In some examples of the method, apparatuses, and non-transitory computer-readable medium described herein, the one or more first channels of the first dynamic frequency selection type may be dynamic frequency selection channels, and the one or more second channels of the second dynamic frequency selection type may be non-dynamic frequency selection channels.

Some examples of the method, apparatuses, and non-transitory computer-readable medium described herein may further include operations, features, means, or instructions for updating a bitmap during the channel availability check procedure to indicate that the one or more first channels may be unavailable for transmission, where transmitting the one or more beacons may be based on updating the bitmap.

Some examples of the method, apparatuses, and non-transitory computer-readable medium described herein may further include operations, features, means, or instructions for including the bitmap in the one or more beacons transmitted to the station during the channel availability check procedure.

Some examples of the method, apparatuses, and non-transitory computer-readable medium described herein may further include operations, features, means, or instructions for updating the bitmap, upon expiration of the channel availability check procedure, to indicate that at least one of the one or more first channels may be available for transmission based on the channel availability check procedure and transmitting, after expiration of the channel availability check procedure, one or more additional beacons on at least one of the one or more second channels and at least one of the one or more first channels according to the updated bitmap, where the updated bitmap may be included in the one or more additional beacons.

Some examples of the method, apparatuses, and non-transitory computer-readable medium described herein may further include operations, features, means, or instructions for updating the bitmap, upon expiration of the channel availability check procedure, to indicate that at least one of the one or more first channels may be unavailable for transmission based on the channel availability check procedure, initiating, after expiration of the channel availability check procedure, a second channel availability check procedure to determine if radar may be being used on one or more additional first channels, and updating the bitmap, upon expiration of the second channel availability check procedure, to indicate that at least one of the one or more additional first channels may be available or unavailable for transmission based on the second channel availability check procedure.

In some examples of the method, apparatuses, and non-transitory computer-readable medium described herein, including the bitmap in the one or more beacons may include operations, features, means, or instructions for transmitting the bitmap in an extremely high throughput operation information element (IE) of the one or more beacons.

Some examples of the method, apparatuses, and non-transitory computer-readable medium described herein may further include operations, features, means, or instructions for including, in the one or more beacons and with the bitmap, an indication of a duration for which the bitmap may be valid.

In some examples of the method, apparatuses, and non-transitory computer-readable medium described herein, the duration may be indicated in units of time, transmission time intervals, or beacons.

Some examples of the method, apparatuses, and non-transitory computer-readable medium described herein may further include operations, features, means, or instructions for determining that the communications band may be associated with a low-latency network, where updating the bitmap may be based on the determining.

In some examples of the method, apparatuses, and non-transitory computer-readable medium described herein, each bit of the bitmap corresponds to one of the one or more first channels or one of the one or more second channels.

In some examples of the method, apparatuses, and non-transitory computer-readable medium described herein, the access point includes a phone and the station includes a virtual reality device.

Some examples of the method, apparatuses, and non-transitory computer-readable medium described herein may further include operations, features, means, or instructions for monitoring, during the channel availability check procedure while simultaneously transmitting the one or more beacons, the one or more first channels for radar use and determining whether detected radar on the one or more first channels satisfies a threshold amount of interference.

### BRIEF DESCRIPTION OF THE DRAWINGS

FIG. 1 illustrates an example of a wireless communications system that supports transmissions on mixed dynamic frequency selection channels during a channel availability check in accordance with aspects of the present disclosure.

FIG. 2A and 2B illustrate examples of wireless communications systems that support transmissions on mixed dynamic frequency selection channels during a channel availability check in accordance with one or more aspects of the present disclosure.

FIG. 3 illustrates an example of a timeline that supports transmissions on mixed dynamic frequency selection channels during a channel availability check in accordance with one or more aspects of the present disclosure.

FIG. 4 illustrates an example of a process flow that supports transmissions on mixed dynamic frequency selection channels during a channel availability check in accordance with one or more aspects of the present disclosure.

FIGS. 5 and 6 show block diagrams of devices that support transmissions on mixed dynamic frequency selection channels during a channel availability check in accordance with one or more aspects of the present disclosure.

FIG. 7 shows a block diagram of a communications manager that supports transmissions on mixed dynamic frequency selection channels during a channel availability check in accordance with one or more aspects of the present disclosure.

FIG. 8 shows a diagram of a system including a device that supports transmissions on mixed dynamic frequency selection channels during a channel availability check in accordance with one or more aspects of the present disclosure.

FIGS. 9 through 11 show flowcharts illustrating methods that support transmissions on mixed dynamic frequency selection channels during a channel availability check in accordance with one or more aspects of the present disclosure.

### DETAILED DESCRIPTION

In some examples, an access point (AP) may operate in a 5 GHz band. In some examples, the AP may operate in a low latency network, and may communicate on one or more dynamic frequency selection (DFS) channels. For example, on a 160 MHz channel, the AP may operate on one or more 20 MHz DFS channels. These channels may also be used for radar signaling. As such, an AP using DFS channels may perform a mandatory channel availability check (CAC) before beaconing. During the CAC, the AP may monitor for radar (e.g., on the DFS channels). While monitoring for radar, the AP may refrain from transmitting, and thus may not transmit any beacons during the CAC. The CAC may last a few seconds or several minutes. During this time period, one or more stations (STAs) may not be able to establish a connection or maintain a connection with the AP, resulting in failed communications, inability to establish a connection, interrupted services, one or more failed operations, and poor user experience.

As described herein, the AP may update a bitmap (e.g., an extremely high throughput (EHT) operation (Ops) information element (IE)) that indicates which channels of a band are available and unavailable. In some examples, the AP may update the bitmap during a CAC based on whether various channels are DFS channels or non-DFS channels. During the CAC, the AP may transmit beacons to one or more STAs on the available non-DFS channels (e.g., instead of waiting until after the CAC to perform any beaconing). This may allow the AP to continue beaconing during CAC procedures, instead of being unavailable to STAs. Such techniques may in turn support low latency communications and avoid unnecessary delays in service (e.g., for virtual reality (VR) devices, or other low latency operations, etc.). Upon expiration of the CAC, the AP may update the bitmap to indicate the full channel is available (e.g., if the CAC is successful on the DFS channels), and may beacon on the full channel. If the CAC is unsuccessful on one or more DFS channels, then the STA may update the bitmap to indicate the unavailable DFS channels, and may initiate a second CAC to identify available DFS or other channels. In some examples, the AP may transmit (e.g., in a beacon transmitted during the CAC) an indication of the updated bitmap, an indication of a duration during which the bitmap is valid, or both.

Aspects of the disclosure are initially described in the context of a wireless communications system. Aspects of the disclosure are further illustrated by and described with reference to wireless communications systems, timelines, and process flows. Aspects of the disclosure are further illustrated by and described with reference to apparatus diagrams, system diagrams, and flowcharts that relate to transmissions on mixed dynamic frequency selection channels during a channel availability check.

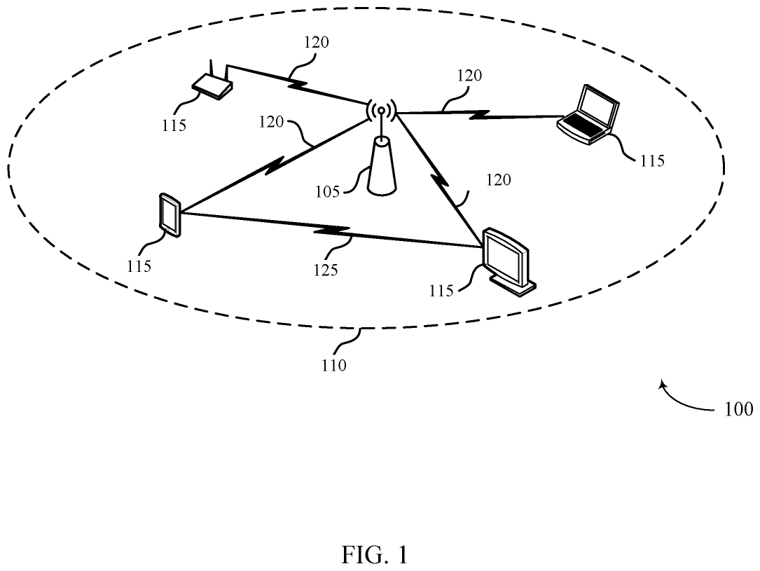

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS.

In some examples, the AP 105 may update a bitmap (e.g., an EHT Ops IE) that indicates which channels of a band are available and unavailable. In some examples, the AP 105 may update the bitmap during a CAC based on whether various channels are DFS channels or non-DFS channels. During the CAC, the AP 105 may transmit beacons to one or more STAs 115 on the available non-DFS channels (e.g., instead of waiting until after the CAC to perform any beaconing). This may allow the AP 105 to continue beaconing during CAC procedures, instead of being unavailable to STAs 115. Such techniques may in turn support low latency communications and avoid unnecessary delays in service (e.g., for virtual reality (VR) devices, or other low latency operations, etc.). Upon expiration of the CAC, the AP 105 may update the bitmap to indicate the full channel is available (e.g., if the CAC is successful on the DFS channels), and may beacon on the full channel.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and medium access control (MAC) layers from IEEE 802.11 and versions including, but not limited to, 802.11b, 802.11g, 802.11a, 802.11n, 802.11ac, 802.11ad, 802.11ah, 802.11ax, 80211be, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier-sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request-to-send (RTS) packet transmitted by a sending STA 115 (or AP 105) and a clear-to-send (CTS) packet transmitted by the receiving STA 115 (or AP 105). This may alert other devices within range of the sender and receiver not to transmit for the duration of the primary transmission. Thus, RTS/CTS may help mitigate a hidden node problem.

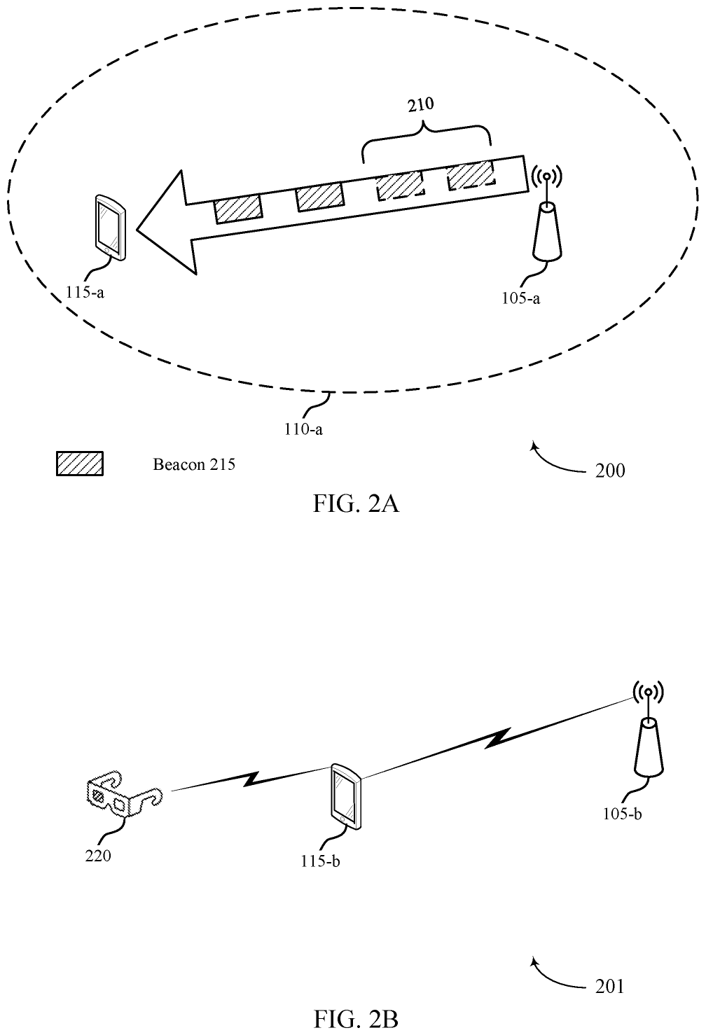

FIG. 2A illustrates an example of a wireless communications system 200 that supports transmissions on mixed dynamic frequency selection channels during a channel availability check in accordance with one or more aspects of the present disclosure. Wireless communications system 200 may include an AP 105-a, and a STA 115-a, which may be examples of corresponding devices described with reference to FIG. 1. In some examples, the AP 105-a may serve one or more STAs 115-a within a coverage area 110-a.

The AP 105-a may transmit (e.g., periodically) one or more beacons 215. The beacons 215 may enable any STAs 115 within wireless range of the AP 105-a to establish or maintain a communication link with the WLAN. Beacons 215 may convey capability information for one or more BSSs managed by the AP 105-a . Thus, if the AP 105-a refrains from transmitting the beacons 215 for a period of time, then the STA 115-a may not be able to establish or maintain a connection with the AP 105-a, which may result in failed communications, retransmissions of wireless communications, delays and increased latency at the STA 115-a, and decreased user experience. For instance, the AP 105-a and the STA 115-a may support virtual reality operations (e.g., the AP 105-a may be a portable device, gaming system, smart device, smart phone, user equipment, or the like). If the AP 105-a does not transmit beacons 215, then the virtual reality operations may be stalled, or may otherwise fail, due to lack of beacons 215 from the AP 105-a.

In some examples, the AP 105-a may operate in one or more bands (e.g., a 5 GHz band). Radar transmissions may also be performed via one or more channels of the 5 GHz band. In some examples, the STA 115-a may support dynamic frequency selection (DFS) procedures to facilitate communications on the 5 GHz band without experience interference or disruptions due to radar transmissions. The AP 105-a may communicate with one or more STAs 115-a via the one or more channels or subchannels of various types. The AP 105-a may communicate on one or more first DFS type channels (e.g., DFS channels) and may also communicate one on or more second DMS type channels (e.g., non-DFS channels). DFS channels may support spectrum-sharing mechanisms that allow WLAN devices operating in a 5 GHz band to coexist with radar systems operating in the same band.

DFS procedures may provide for the AP 105-a to perform a channel availability check (CAC) 210 to search for radar pulses in the frequency channel where the AP 105-a is operating, or during an automatic channel scan. During a CAC 210, the AP 105-a may refrain from transmitting beacons 215, and may instead monitor for radar signals. If the AP 105-a does not encounter any radar during the CAC 210 (e.g., during a CAC timepoint period), then the AP 105-a may perform transmission and reception (e.g., including transmission of beacons 215) on the channel or channels monitoring during the CAC 210 upon expiration of the CAC 210. If the AP 105-a detects radar signals in a current channel of operation (e.g., a 20 MHz channel within the 5 GHz band) during the CAC 210, then the AP 105-a may discontinue operation on that channel for a period of time (e.g., for thirty minutes). The AP 105-a may then select a new channel, and may repeat DFS procedures (e.g., initiate a second CAC 210 on a new channel) until available channels (e.g., where no radar is encountered) are identified.

The CAC 210 may take a defined (e.g., standardized) period of time (e.g., thirty seconds, one minute, thirty minutes, etc.). The AP 105-a may not perform any transmission or reception for a BSS during the CAC 210, which may affect network traffic during the time frame of the CAC 210. If the AP 105-a refrains from transmitting beacons 215 during the entirety of the CAC 210, then one or more communications or operations between the AP 105-a and the STA 115-a may fail (e.g., the STA 115-a may not be able to find and establish a connection with the AP 105-a, or may not be able to maintain communications with the AP 105-a). For instance, in a low latency network (e.g., supporting STA 115-a, where STA 115-a is a VR device, an AR device, an extended reality (XR) device, or the like, and AP 105-a is a soft AP, such as a phone), if the STA-AP must wait for beacons for an entire CAC procedure duration, then time may be wasted, connections may fail, operations may be suspended, or the like, resulting in poor user experience.

In some examples, the AP 105-a may be configured to operate according to an EHT (extremely high throughput) mode on one or more channels (e.g., in a 5 GHz band). In such examples, the AP 105-a may identify (e.g., generate or be configured with) a list of DFS channels and non-DFS channels. The AP 105-a may identify or indicate which channels are or are not to be used according to a bitmap (e.g., an EHT Ops IE, which may be referred to as a disabled subchannel bitmap). In some examples, the bitmap may indicate which channels are available for use, and which channels are unavailable for use. The bitmap may indicate that a subchannel is disabled or enabled or available for a fixed period of time, until otherwise indicated, or the like. The bitmap may indicate available or unavailable channels, subchannels, bands, or portions of bands, bandwidths, or any combination thereof. Although described herein in terms of an indication of channels or subchannels, the bitmap (e.g., the disable sub-channel bitmap) as described may be implemented according to described techniques to enable or disable any subdivision of frequency resources (e.g., channels, sub-channels, bands, bandwidths, etc.). In some examples, the Ap 105-a may communicate (e.g., with one or more STAs 115) using channels that are indicated as available according to the bitmap, and may refrain from communications (e.g., with one or more STAs 115) using channels that are indicated as unavailable according to the bitmap.

According to techniques described herein, the AP 105-a may mark DFS channels as unavailable or not to be used during a CAC 210 (e.g., may update the bitmap to indicate that DFS channels of a 5 GHz band are unavailable). In such examples, the AP 105-a may refrain from transmitting or receiving (e.g., from transmitting beacons 215) on unavailable DFS channels during the CAC 210. However, the AP 105-a may transmit beacons 215 on available non-DFS channels (e.g., according to the updated bitmap) during the CAC 210. The AP 105-a may continue to beacon on non-DFS channels (e.g., at a lower bandwidth) during the CAC duration. For instance, the AP 105-a may refrain from transmissions on DFS channels (e.g., 20 MHz channels on the 5 GHz band), but may continue to beacon on non-DFS channels (e.g., 20 MHz channels on a different band).

Upon expiration of the CAC 210, AP 105-a may update the bitmap (e.g., the disabled subchannel bitmap) in the EHT ops to indicate full bandwidth support (e.g., if the AP 105-a did not encounter any radar on the DFS channels during the CAC 210). In some examples (e.g., in case of in-service radar monitoring), the AP 105-a may encounter radar on one or more DFS channels during the CAC 210. In such examples, the STA 115-a may update the bitmap (e.g., the disabled sub-channel bitmap) to silent out (e.g., mark as unavailable) radar affected channels (e.g., 20 MHz channels or subchannels). The AP 105-a may initiate another CAC 210, and may refrain from beaconing on unavailable channels or subchannels, but may continue to beacon on available channels or subchannels, according to the bitmap. That is, the AP 105-a may silent out radar affected 20 MHz sub-channels, but may service the rest of available channels (e.g., non-DFS 20 MHz subchannels) while performing CSA or CAC 210 on DFS sub-channels.

By implementing techniques described herein, the AP 105-a and the STA 115-a may continue to support connectivity and various operations during a CAC 210 (e.g., during a timeout period associated with the CAC 210). Continued transmission (e.g., of beacons 215, data, or other transmission types) on available channels (e.g., non-DFS channels) during a CAC 210 may support continued and uninterrupted communications between the AP 105-a and the STA 115-a, improved communication, and more efficient use of available resources, may avoid interruptions to operations (e.g., including low-latency communication, virtual reality (VR) or augmented reality (AR) operations), or the like.

FIG. 2B illustrates an example of a wireless communications system 201 that supports transmissions on mixed dynamic frequency selection channels during a channel availability check in accordance with one or more aspects of the present disclosure. Wireless communications system 201 may include an AP 105-b, and a STA 115-b, which may be examples of corresponding devices described with reference to FIG. 1 and FIG. 2A.

In some examples, a UE 115-b (e.g., a smart phone) may act as a soft AP. In such examples, the UE 115-b may perform low latency communications with a device 220 (e.g., a VR or AR device, such as VR glasses). The device 220 may be connected to the UE 115-b via a soft AP link, and the UE 115-b may be connected to a WLAN via a WLAN AP 105-b. In such examples, as described herein, the UE 115-b (e.g., acting as a soft AP) may transmit one or more beacons (e.g., beacons 215) to the device 220. As described with reference to FIGS. 2A, 3, and 4, the UE 115-b may perform beaconing during a CAC. For example, the UE 115-b may mark DFS channels as unavailable or not to be used during a CAC 210 (e.g., may update the bitmap to indicate that DFS channels of a 5 GHz band are unavailable). In such examples, the UE 115-b may refrain from transmitting or receiving (e.g., from transmitting beacons 215) on unavailable DFS channels during a CAC 210. However, the UE 115-b may transmit beacons 215 on available non-DFS channels (e.g., according to the updated bitmap) during the CAC 210. The UE 115-b may continue to beacon on non-DFS channels (e.g., at a lower bandwidth) during the CAC duration.

Upon expiration of the CAC 210, the UE 115-b may update the bitmap (e.g., the disabled subchannel bitmap) in the EHT ops to indicate full bandwidth support (e.g., if the UE 115-b did not encounter any radar on the DFS channels during the CAC 210). In some examples (e.g., in case of in-service radar monitoring), the UE 115-b may encounter radar on one or more DFS channels during the CAC 210. In such examples, the UE 115-b may update the bitmap (e.g., the disabled sub-channel bitmap) to silent out (e.g., mark as unavailable) radar affected channels (e.g., 20 MHz channels or subchannels). The UE 115-b may initiate another CAC 210, and may refrain from beaconing on unavailable channels or subchannels, but may continue to beacon on available channels or subchannels, according to the bitmap. That is, the UE 115-b may silent out radar affected 20 MHz sub-channels, but may service the rest of available channels (e.g., non-DFS 20 MHz subchannels) while performing CSA or CAC 210 on DFS sub-channels.

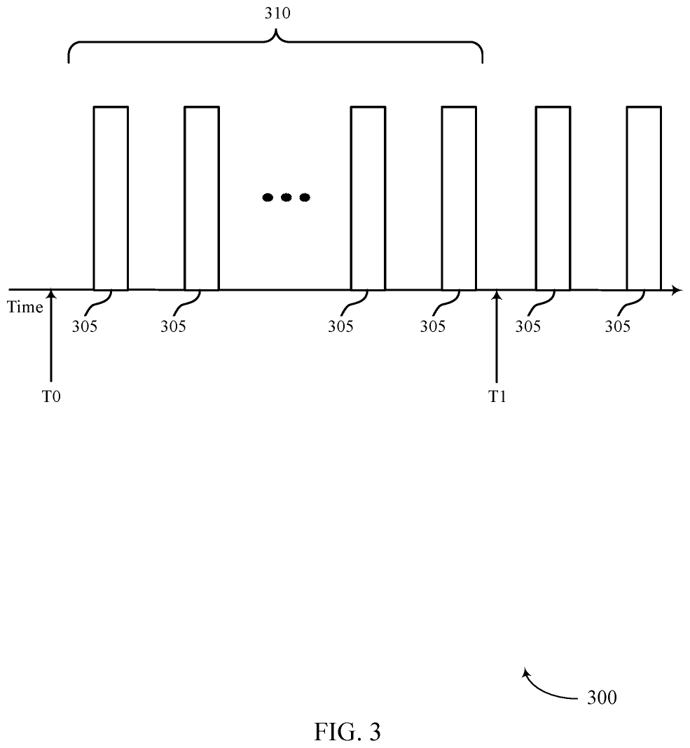

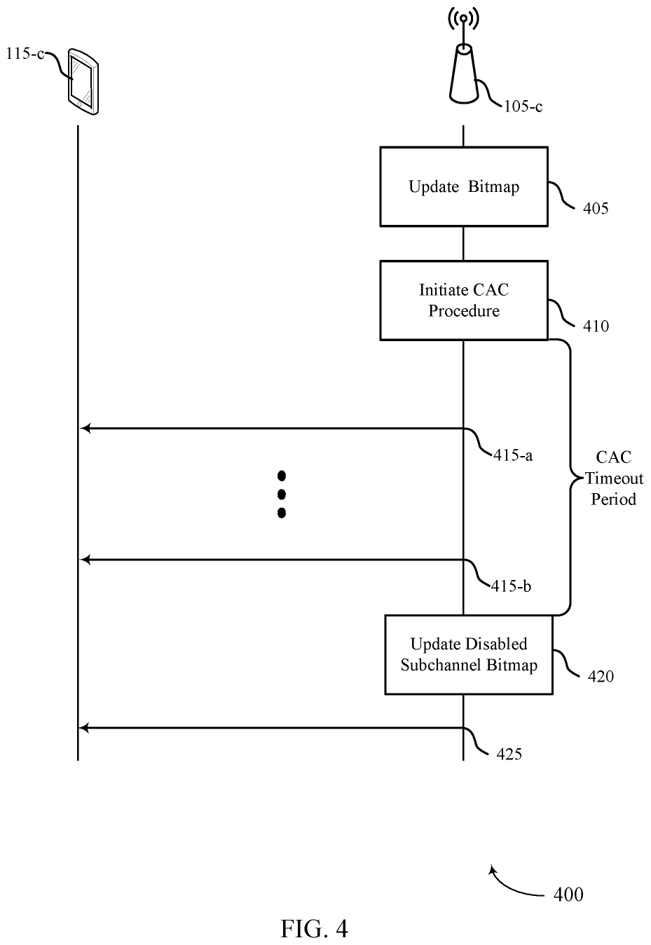

By implementing techniques described herein, the UE 115-b and the device 220 may continue to support connectivity and various operations during a CAC 210 (e.g., during a timeout period associated with the CAC 210). Continued transmission (e.g., of beacons 215, data, or other transmission types) on available channels (e.g., non-DFS channels) during a CAC 210 may support continued and uninterrupted communications between the UE 115-b and the device 220, improved communication, and more efficient use of available resources, may avoid interruptions to operations (e.g., including low-latency communication, VR or AR operations), or the like. Techniques described with reference to FIG. 3 and FIG. 4 that refer to an AP and a UE may similarly be performed by UE 115-b (e.g., acting in a soft AP mode) and device 220).

FIG. 3 illustrates an example of a timeline 300 that supports transmissions on mixed dynamic frequency selection channels during a channel availability check in accordance with one or more aspects of the present disclosure. Timeline 300 may implement aspects of, or may be implemented by aspects of, WLAN 100 and wireless communications system 200 and wireless communication system 201. For example, an AP (e.g., an AP 105-a) and a STA (e.g., a STA 115-a) may implement timeline 300, and may perform techniques described with reference to FIGS. 1-2. In some examples, such an AP and STA may communicate with each other (e.g., may support operations, including VR or AR operations) according to techniques described herein. In some examples, the AP 105-a may be a phone, and the STA 115-c may be a VR device (e.g., a headset, wearable device, goggles, controller, or the like).

The Ap may transmit one or more beacons 305, supporting connection establishment and maintenance, as described in greater detail with reference to FIG. 2A and FIG. 2B. In some examples (e.g., when operating on a 5 GHz band), the AP may initiate a CAC 310. Prior to initiating the CAC 310 (e.g., or upon initiating the CAC 310 or during the CAC 310), the AP may update a bitmap (e.g., a disabled subchannel bitmap). For instance, at time T0, the AP may update the bitmap to indicate one or more DFS channels as unavailable.

During the CAC 310, the AP may transmit beacons 305 according to the updated bitmap. For example, the AP may transmit 5 GHz beacons 305 with the bitmap set for all DFS 20 MHz subchannels. In such examples, the AP may transmit the beacons 305 on non-DFS 20 MHz subchannels, but may refrain from transmitting the beacons 305 on DFS 20 MHz subchannels. The AP may monitor the DFS 20 MHz subchannels for radar while simultaneously transmitting the beacons 305 on non-DFS 20 MHz subchannels.

Upon expiration of the CAC 310, the AP may update the bitmap. For example, at time T1, the Ap may determine whether it detected any radar on the monitored unavailable channels (e.g., the DFS 20 MHz subchannels). For instance, the AP may determine whether any detected energy satisfied one or more thresholds. The Ap may then update the bitmap accordingly. For example, if no radar was detected on one or more of the DFS channels, then the AP may update the bitmap to indicate that those DFS channels are available (e.g., may set the bits of the bitmap to available). For instance, if the AP detected no radar on the DFS channels, then the AP may set the bitmap to indicate full bandwidth support or availability. In some examples, at T1, the AP may update the bitmap and rest it per AP configuration, as the CAC 310 duration is served.

In some examples, the AP may detect radar on one or more of the DFS channels during the CAC 310. In such examples, the AP may update the bitmap accordingly. For example, the AP may set the bits of the bitmap (e.g., that are associated with the identified channels in which radar was detected) to indicate that the channels on which radar was detected are unavailable. In such examples, the AP may also initiate a second CAC, and may monitor one or more additional channels (e.g., one or more additional DFS channels), to determine channel availability. Upon expiration of the second CAC, the AP may again update the bitmap (e.g., indicating channels on which radar was detected as unavailable, and indicating channels on which no radar was detected as available).

FIG. 4 illustrates an example of a process flow 400 that supports transmissions on mixed dynamic frequency selection channels during a channel availability check in accordance with one or more aspects of the present disclosure. Process flow 400 may include a STA 115-c and an AP 105-c, which may be examples of corresponding devices described with reference to FIGS. 1-3.

At 410, the AP 105-c may initiate a CAC (e.g., having a CAC timeout period). In some examples, the AP 105-c may identify that a communication band includes one or more first channels of a first DFS type (e.g., DFS channels), and one or more second channels of the second DFS type (e.g., non-DFS channels). The AP 105-c may initiate the CAC procedure to determine if radar is being used on one or more of the first channels (e.g., the DFS channels).

In some examples, at 405, the AP 105-c may update a bitmap (e.g., an EHT Ops IE disabled-subchannel bitmap). The AP 105-c may update the bitmap to indicate that one or more of the DFS channels are unavailable (e.g., may set each bit that corresponds with a DFS channel to indicate that the DFS channel is unavailable). The AP 105-c may update bitmap prior to initiating the CAC procedure at 410 (e.g., to indicate that the indicated channels are unavailable during the CAC timeout period), or may update the bitmap upon initiation of the CAC procedure or during the CAC timeout period. In some cases, the AP 105-c may determine that one or more conditions are satisfied, and may update the bitmap based on the determination. For instance, the AP 105-a may determine that a wireless channel (e.g., one or more DFS channels, one or more non-DFS channels, or both) is associated with a low-latency network. In such examples, the AP 105-a may update the bitmap based on determining that the channel is associated with a low-latency network.

At 415, the AP 105-c may transmit (e.g., to the STA 115-c during the CAC timeout period) one or more beacons on at least one of the one or more non-DFS channels according to the updated bitmap. The AP 105-c may transmit the beacons at 415 periodically (e.g., a first beacon on the non-DFS channels at 415-a, and a second beacon on the non-DFS channels at 415-b). The AP 105-c may not transmit on any of the DFS channels (e.g., that are indicated as unavailable on the bitmap updated at 405). In some examples, the AP 105-c may monitor, during the CAC procedure while simultaneous transmitting the one or more beacons, the DFS channels for radar use, and may determine whether detected radar on the DFS channels satisfies a threshold amount of interference.

In some examples, the AP 105-c may include an indication of the updated bitmap in one or more of the beacons (e.g., transmitted at 415, or prior to initiating the CAC procedure). For instance, the AP 105-c may update the bitmap at 405, and may include an indication of the updated bitmap in a beacon. In some examples, the AP 105-a may include the bitmap in an EHT ops IE of the beacon. The AP 105-a may include, in the beacon, an indication of a duration for which the bitmap is valid (e.g., a fixed amount of time, a number of time intervals, a number of beacons, a number of periods for the periodic beacon, or the like). For instance, the AP 105-a may transmit (e.g., in the beacon, or in a separate message) an indication of the duration (e.g., target beacon transmission time (TBTT) information) for which the disable subchannel bitmap holds. Such information may allow other devices (e.g., STAs 115 or APs 105) to determine channel availability and plan traffic accordingly. For instance, the AP 105-a may signal a time remaining (e.g., a timer, an amount of time, a counter, a number of slots of beacons, etc.), for the DFS channels. Such information could be included in a duration indicator element.

In such examples, the STA 115-c may receive a beacon that includes the indication of the updated bitmap, and may monitor one or more channels accordingly. For instance, the STA 115-c may monitor non-DFS channels for beacons (e.g., at 415-a, 415-b, etc.), but may refrain from monitoring for beacons on DFS channels (e.g., according to the updated bitmap, for the duration for which the bitmap is valid). This may result in more efficient power expenditures at the STA 115-c, or more efficient reception of beacons 415, and consistent communication via a reliable connection with the AP 105-c.

At 420, upon expiration of the CAC procedure (e.g., upon expiration of the CAC timeout period), the AP 105-c may update the bitmap based on the CAC procedure. For example, the AP 105-c may not detect any radar during the CAC procedure (e.g., any detected energy may fail to satisfy a threshold amount of energy) on the one or more DFS channels. In such examples, at 420, the AP 105-c may update the bitmap to indicate that at least one of the one or more DFS channels is available for transmissions based at least in part on the CAC procedure. For instance, the AP 105-c may update the bitmap to indicate full bandwidth availability. In such examples, at 425, the Ap 105-c may transmit one or more additional beacons on at least one of the DFS channels (e.g., and on any available non-DFS channels) according to the updated bitmap. In some examples, the AP 105-c may also include an indication of the updated bitmap in one or more additional beacons (e.g., at 425, subsequent to updating the bitmap at 420).

In some examples, the AP 105-c may detect radar on one or more of the DFS channels. In such examples, at 420, the AP 105-c may update the bitmap upon expiration of the CAC procedure to indicate that one or more of the DFS channels is unavailable. The AP 105-c may also initiate (e.g., upon expiration of the CAC procedure and upon updating the bitmap) a second CAC procedure to determine if radar is being used on one or more additional DFS channels. Upon expiration of the second CAC procedure, the AP 105-c may update the bitmap again, to indicate whether the additional DFS channels are available for transmissions based on the second CAC procedure. In some examples, the AP 105-c may perform continuous or repeated CAC procedures, to identify available DFS channels. During each CAC procedure, the AP 105-c may transmit beacons on channels (e.g., DFS channels or non-DFS channels or both) that are indicated as being available according to the most recent updates of the bitmap.

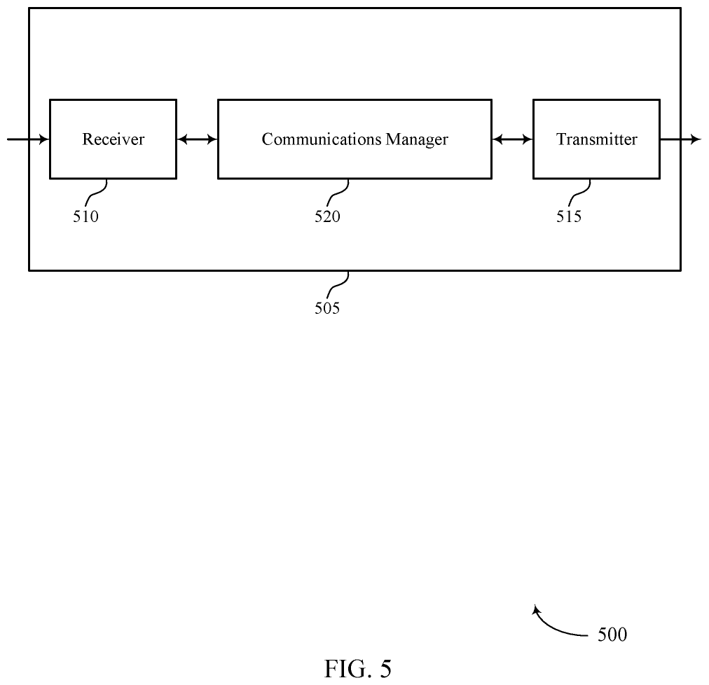

FIG. 5 shows a block diagram 500 of a device 505 that supports transmissions on mixed dynamic frequency selection channels during a channel availability check in accordance with one or more aspects of the present disclosure. The device 505 may be an example of aspects of an AP as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to transmissions on mixed dynamic frequency selection channels during a channel availability check). Information may be passed on to other components of the device 505. The receiver 510 may utilize a single antenna or a set of multiple antennas.

The transmitter 515 may provide a means for transmitting signals generated by other components of the device 505. The transmitter 515 may utilize a single antenna or a set of multiple antennas.

The communications manager 520, the receiver 510, the transmitter 515, or various combinations thereof or various components thereof may be examples of means for performing various aspects of transmissions on mixed dynamic frequency selections channel during a channel availability check as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at an access point in accordance with examples as disclosed herein. For example, the communications manager 520 may be configured as or otherwise support a means for identifying that a communications band includes one or more first channels of a first dynamic frequency selection type and one or more second channels of a second dynamic frequency selection type. The communications manager 520 may be configured as or otherwise support a means for performing a channel availability check procedure to determine if radar is being used on one of the one or more first channels. The communications manager 520 may be configured as or otherwise support a means for transmitting, to a station during the channel availability check procedure, one or more beacons on at least one of the one or more second channels.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for beaconing during a CAC procedure, resulting in more reliable connections, more efficient use of available resources, more reliable services and operations, decreased delays and system latency, and improved user experience.

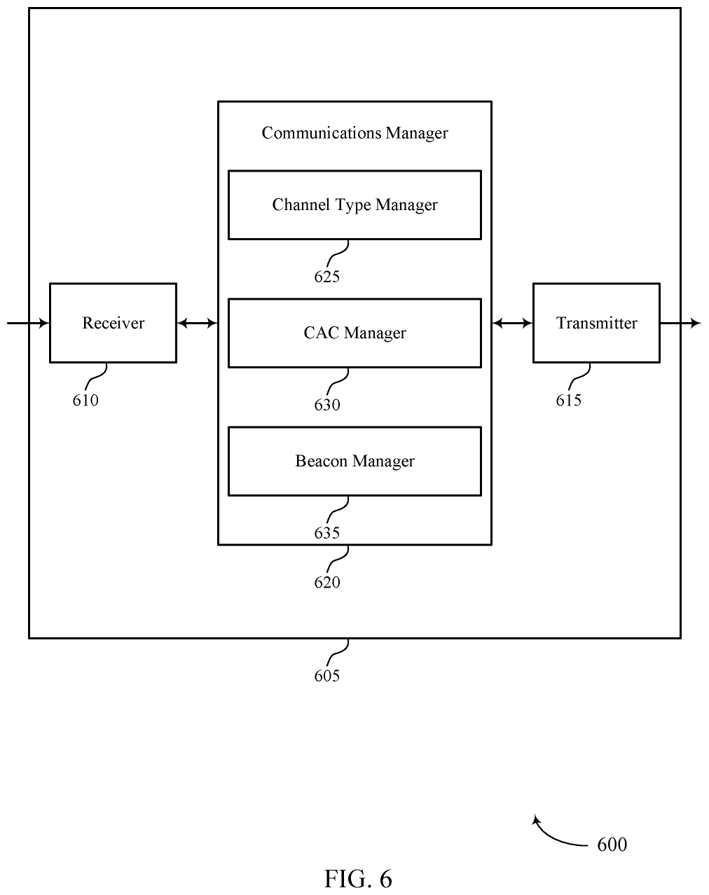

FIG. 6 shows a block diagram 600 of a device 605 that supports transmissions on mixed dynamic frequency selection channels during a channel availability check in accordance with one or more aspects of the present disclosure. The device 605 may be an example of aspects of a device 505 or an AP 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to transmissions on mixed dynamic frequency selection channels during a channel availability check). Information may be passed on to other components of the device 605. The receiver 610 may utilize a single antenna or a set of multiple antennas.

The transmitter 615 may provide a means for transmitting signals generated by other components of the device 605. The transmitter 615 may utilize a single antenna or a set of multiple antennas.

The device 605, or various components thereof, may be an example of means for performing various aspects of transmissions on mixed dynamic frequency selection channels during a channel availability check as described herein. For example, the communications manager 620 may include a channel type manager 625, a CAC manager 630, a beacon manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at an access point in accordance with examples as disclosed herein. The channel type manager 625 may be configured as or otherwise support a means for identifying that a communications band includes one or more first channels of a first dynamic frequency selection type and one or more second channels of a second dynamic frequency selection type. The CAC manager 630 may be configured as or otherwise support a means for performing a channel availability check procedure to determine if radar is being used on one of the one or more first channels. The beacon manager 635 may be configured as or otherwise support a means for transmitting, to a station during the channel availability check procedure, one or more beacons on at least one of the one or more second channels.

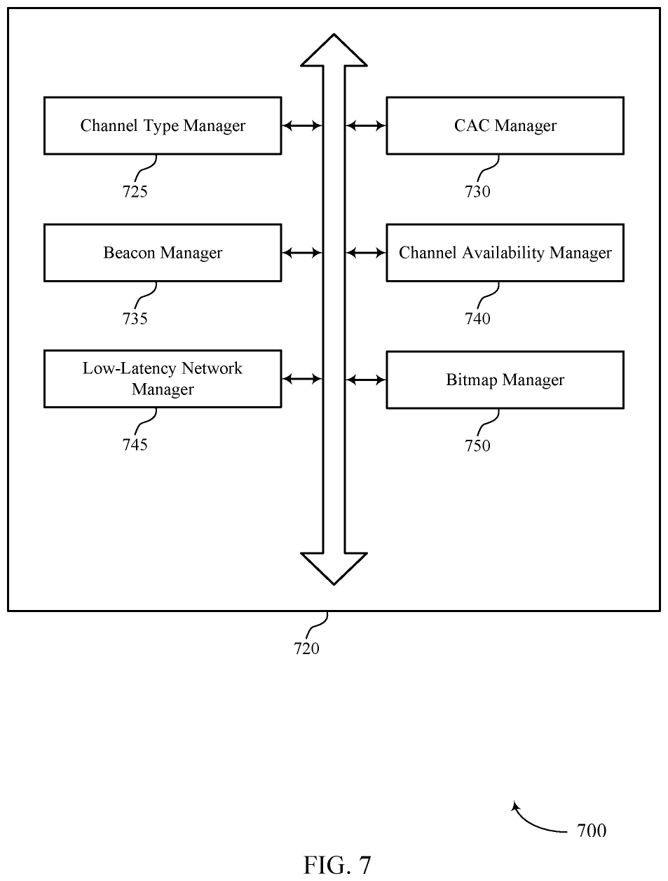

FIG. 7 shows a block diagram 700 of a communications manager 720 that supports transmissions on mixed dynamic frequency selection channels during a channel availability check in accordance with one or more aspects of the present disclosure. The communications manager 720 may be an example of aspects of a communications manager 520, a communications manager 620, or both, as described herein. The communications manager 720, or various components thereof, may be an example of means for performing various aspects of transmissions on mixed dynamic frequency selection channels during a channel availability check as described herein. For example, the communications manager 720 may include a channel type manager 725, a CAC manager 730, a beacon manager 735, a channel availability manager 740, a bitmap manager 750, a low-latency network manager 745, or any combination thereof. Each of these components may communicate, directly or indirectly, with one another (e.g., via one or more buses).

The communications manager 720 may support wireless communications at an access point in accordance with examples as disclosed herein. The channel type manager 725 may be configured as or otherwise support a means for identifying that a communications band includes one or more first channels of a first dynamic frequency selection type and one or more second channels of a second dynamic frequency selection type. The CAC manager 730 may be configured as or otherwise support a means for performing a channel availability check procedure to determine if radar is being used on one of the one or more first channels. The beacon manager 735 may be configured as or otherwise support a means for transmitting, to a station during the channel availability check procedure, one or more beacons on at least one of the one or more second channels.

In some examples, the one or more first channels of the first dynamic frequency selection type are dynamic frequency selection channels, and the one or more second channels of the second dynamic frequency selection type are non-dynamic frequency selection channels.

In some examples, the channel availability manager 740 may be configured as or otherwise support a means for updating a bitmap during the channel availability check procedure to indicate that the one or more first channels are unavailable for transmission, where transmitting the one or more beacons is based on updating the bitmap.

In some examples, the bitmap manager 750 may be configured as or otherwise support a means for including the bitmap in the one or more beacons transmitted to the station during the channel availability check procedure.

In some examples, the channel availability manager 740 may be configured as or otherwise support a means for updating the bitmap, upon expiration of the channel availability check procedure, to indicate that at least one of the one or more first channels is available for transmission based on the channel availability check procedure. In some examples, the beacon manager 735 may be configured as or otherwise support a means for transmitting, after expiration of the channel availability check procedure, one or more additional beacons on at least one of the one or more second channels and at least one of the one or more first channels according to the updated bitmap, where the updated bitmap is included in the one or more additional beacons.

In some examples, the channel availability manager 740 may be configured as or otherwise support a means for updating the bitmap, upon expiration of the channel availability check procedure, to indicate that at least one of the one or more first channels is unavailable for transmission based on the channel availability check procedure. In some examples, the CAC manager 730 may be configured as or otherwise support a means for initiating, after expiration of the channel availability check procedure, a second channel availability check procedure to determine if radar is being used on one or more additional first channels. In some examples, the channel availability manager 740 may be configured as or otherwise support a means for updating the bitmap, upon expiration of the second channel availability check procedure, to indicate that at least one of the one or more additional first channels is available or unavailable for transmission based on the second channel availability check procedure.

In some examples, to support including the bitmap in the one or more beacons, the bitmap manager 750 may be configured as or otherwise support a means for transmitting the bitmap in an extremely high throughput operation information element (IE) of the one or more beacons.

In some examples, the beacon manager 735 may be configured as or otherwise support a means for including, in the one or more beacons and with the bitmap, an indication of a duration for which the bitmap is valid. In some examples, the duration is indicated in units of time, transmission time intervals, or beacons.

In some examples, the low-latency network manager 745 may be configured as or otherwise support a means for determining that the communications band is associated with a low-latency network, where updating the bitmap is based on the determining.

In some examples, each bit of the bitmap corresponds to one of the one or more first channels or one of the one or more second channels. In some examples, the access point includes a phone. In some examples, the station includes a virtual reality device.

In some examples, the CAC manager 730 may be configured as or otherwise support a means for monitoring, during the channel availability check procedure while simultaneously transmitting the one or more beacons, the one or more first channels for radar use. In some examples, the CAC manager 730 may be configured as or otherwise support a means for determining whether detected radar on the one or more first channels satisfies a threshold amount of interference.

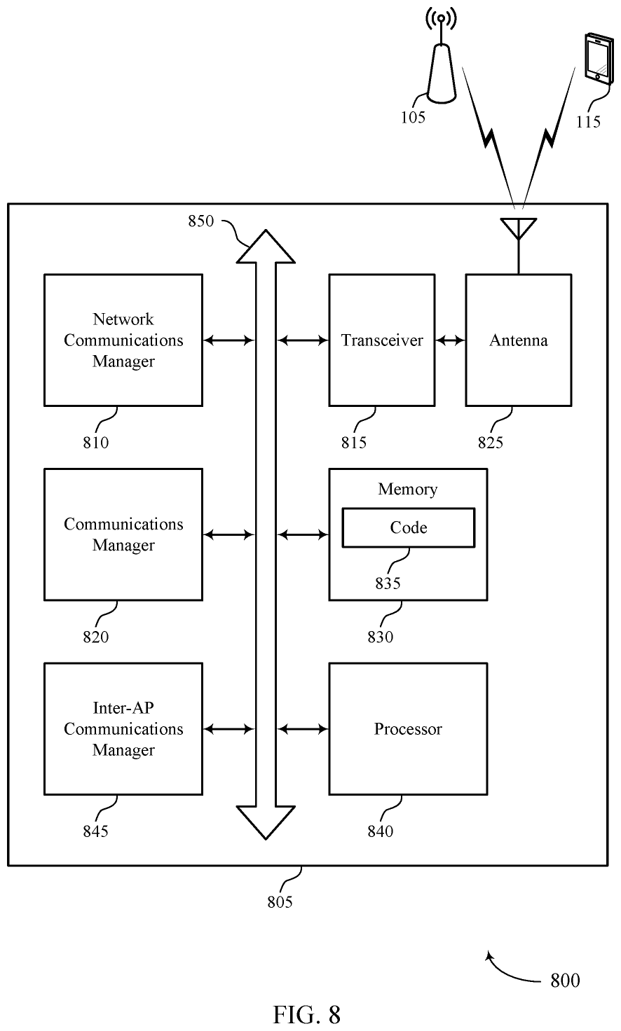

FIG. 8 shows a diagram of a system 800 including a device 805 that supports transmissions on mixed dynamic frequency selection channels during a channel availability check in accordance with one or more aspects of the present disclosure. The device 805 may be an example of or include the components of a device 505, a device 605, or an AP as described herein. The device 805 may include components for bi-directional voice and data communications including components for transmitting and receiving communications, such as a communications manager 820, a network communications manager 810, a transceiver 815, an antenna 825, a memory 830, code 835, a processor 840, and an inter-AP communications manager 845. These components may be in electronic communication or otherwise coupled (e.g., operatively, communicatively, functionally, electronically, electrically) via one or more buses (e.g., a bus 850).

The network communications manager 810 may manage communications with a core network (e.g., via one or more wired backhaul links). For example, the network communications manager 810 may manage the transfer of data communications for client devices, such as one or more STAs 115.

In some cases, the device 805 may include a single antenna 825. However, in some other cases the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets and provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include RAM and ROM. The memory 830 may store computer-readable, computer-executable code 835 including instructions that, when executed by the processor 840, cause the device 805 to perform various functions described herein. In some cases, the memory 830 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting transmissions on mixed dynamic frequency selection channels during a channel availability check). For example, the device 805 or a component of the device 805 may include a processor 840 and memory 830 coupled with or to the processor 840, the processor 840 and memory 830 configured to perform various functions described herein.

The inter-station communications manager 845 may manage communications with other APs 105, and may include a controller or scheduler for controlling communications with STAs 115 in cooperation with other APs 105. For example, the inter-station communications manager 845 may coordinate scheduling for transmissions to APs 105 for various interference mitigation techniques such as beamforming or joint transmission. In some examples, the inter-station communications manager 845 may provide an X2 interface within an LTE/LTE-A wireless communication network technology to provide communication between APs 105.

The communications manager 820 may support wireless communications at an access point in accordance with examples as disclosed herein. For example, the communications manager 820 may be configured as or otherwise support a means for identifying that a communications band includes one or more first channels of a first dynamic frequency selection type and one or more second channels of a second dynamic frequency selection type. The communications manager 820 may be configured as or otherwise support a means for performing a channel availability check procedure to determine if radar is being used on one of the one or more first channels. The communications manager 820 may be configured as or otherwise support a means for transmitting, to a station during the channel availability check procedure, one or more beacons on at least one of the one or more second channels.

By including or configuring the communications manager 820 in accordance with examples as described herein, the device 805 may support techniques for beaconing during a CAC procedure, resulting in more reliable connections, more efficient use of available resources, more reliable services and operations, decreased delays and system latency, and improved user experience.

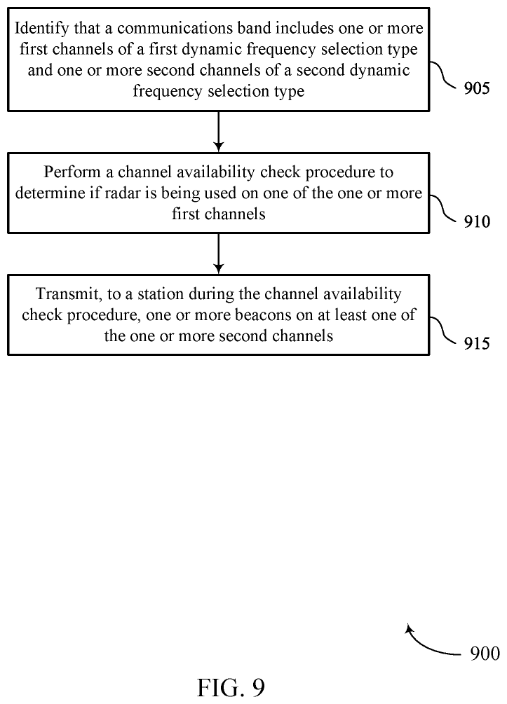

FIG. 9 shows a flowchart illustrating a method 900 that supports transmissions on mixed dynamic frequency selection channels during a channel availability check in accordance with one or more aspects of the present disclosure. The operations of the method 900 may be implemented by an AP or its components as described herein. For example, the operations of the method 900 may be performed by an AP as described with reference to FIGS. 1 through 8. In some examples, an AP may execute a set of instructions to control the functional elements of the AP to perform the described functions. Additionally, or alternatively, the AP may perform aspects of the described functions using special-purpose hardware.

At 905, the method may include identifying that a communications band includes one or more first channels of a first dynamic frequency selection type and one or more second channels of a second dynamic frequency selection type. The operations of 905 may be performed in accordance with examples as disclosed herein. In some examples, aspects of the operations of 905 may be performed by a channel type manager 725 as described with reference to FIG. 7.

At 910, the method may include performing a channel availability check procedure to determine if radar is being used on one of the one or more first channels. The operations of 910 may be performed in accordance with examples as disclosed herein. In some examples, aspects of the operations of 910 may be performed by a CAC manager 730 as described with reference to FIG. 7.

At 915, the method may include transmitting, to a station during the channel availability check procedure, one or more beacons on at least one of the one or more second channels. The operations of 915 may be performed in accordance with examples as disclosed herein. In some examples, aspects of the operations of 915 may be performed by a beacon manager 735 as described with reference to FIG. 7.

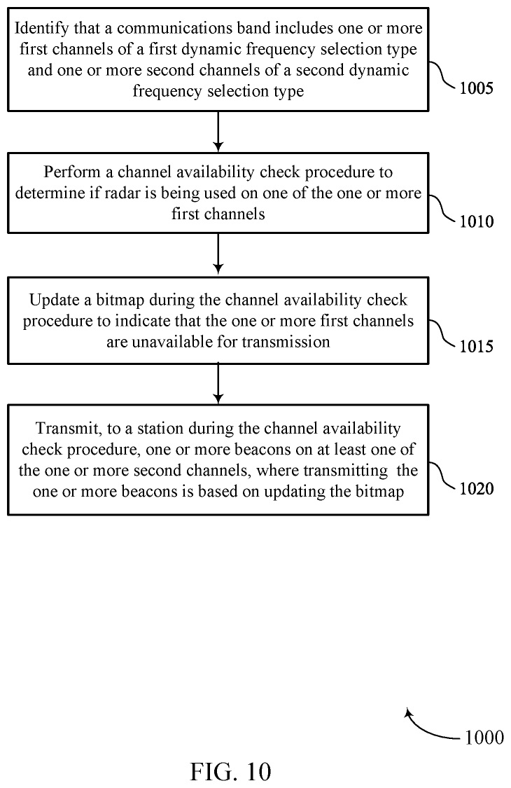

FIG. 10 shows a flowchart illustrating a method 1000 that supports transmissions on mixed dynamic frequency selection channels during a channel availability check in accordance with one or more aspects of the present disclosure. The operations of the method 1000 may be implemented by an AP or its components as described herein. For example, the operations of the method 1000 may be performed by an AP as described with reference to FIGS. 1 through 8. In some examples, an AP may execute a set of instructions to control the functional elements of the AP to perform the described functions. Additionally, or alternatively, the AP may perform aspects of the described functions using special-purpose hardware.

At 1005, the method may include identifying that a communications band includes one or more first channels of a first dynamic frequency selection type and one or more second channels of a second dynamic frequency selection type. The operations of 1005 may be performed in accordance with examples as disclosed herein. In some examples, aspects of the operations of 1005 may be performed by a channel type manager 725 as described with reference to FIG. 7.

At 1010, the method may include performing a channel availability check procedure to determine if radar is being used on one of the one or more first channels. The operations of 1010 may be performed in accordance with examples as disclosed herein. In some examples, aspects of the operations of 1010 may be performed by a CAC manager 730 as described with reference to FIG. 7.

At 1015, the method may include updating a bitmap during the channel availability check procedure to indicate that the one or more first channels are unavailable for transmission. The operations of 1015 may be performed in accordance with examples as disclosed herein. In some examples, aspects of the operations of 1015 may be performed by a channel availability manager 740 as described with reference to FIG. 7.

At 1020, the method may include transmitting, to a station during the channel availability check procedure, one or more beacons on at least one of the one or more second channels, where transmitting the one or more beacons is based on updating the bitmap. The operations of 1020 may be performed in accordance with examples as disclosed herein. In some examples, aspects of the operations of 1020 may be performed by a beacon manager 735 as described with reference to FIG. 7.

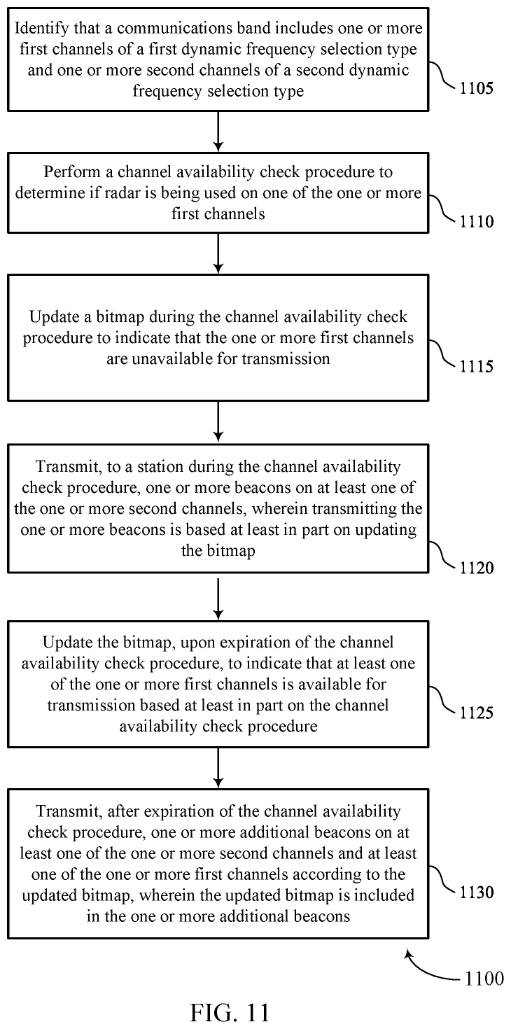

FIG. 11 shows a flowchart illustrating a method 1100 that supports transmissions on mixed dynamic frequency selection channels during a channel availability check in accordance with one or more aspects of the present disclosure. The operations of the method 1100 may be implemented by an AP or its components as described herein. For example, the operations of the method 1100 may be performed by an AP as described with reference to FIGS. 1 through 8. In some examples, an AP may execute a set of instructions to control the functional elements of the AP to perform the described functions. Additionally, or alternatively, the AP may perform aspects of the described functions using special-purpose hardware.

At 1105, the method may include identifying that a communications band includes one or more first channels of a first dynamic frequency selection type and one or more second channels of a second dynamic frequency selection type. The operations of 1105 may be performed in accordance with examples as disclosed herein. In some examples, aspects of the operations of 1105 may be performed by a channel type manager 725 as described with reference to FIG. 7.

At 1110, the method may include performing a channel availability check procedure to determine if radar is being used on one of the one or more first channels. The operations of 1110 may be performed in accordance with examples as disclosed herein. In some examples, aspects of the operations of 1110 may be performed by a CAC manager 730 as described with reference to FIG. 7.

At 1115, the method may include updating a bitmap during the channel availability check procedure to indicate that the one or more first channels are unavailable for transmission. The operations of 1115 may be performed in accordance with examples as disclosed herein. In some examples, aspects of the operations of 1115 may be performed by a channel availability manager 740 as described with reference to FIG. 7.

At 1120, the method may include transmitting, to a station during the channel availability check procedure, one or more beacons on at least one of the one or more second channels, where transmitting the one or more beacons is based on updating the bitmap. The operations of 1120 may be performed in accordance with examples as disclosed herein. In some examples, aspects of the operations of 1120 may be performed by a beacon manager 735 as described with reference to FIG. 7.

At 1125, the method may include updating the bitmap, upon expiration of the channel availability check procedure, to indicate that at least one of the one or more first channels is available for transmission based on the channel availability check procedure. The operations of 1125 may be performed in accordance with examples as disclosed herein. In some examples, aspects of the operations of 1125 may be performed by a channel availability manager 740 as described with reference to FIG. 7.

At 1130, the method may include transmitting, after expiration of the channel availability check procedure, one or more additional beacons on at least one of the one or more second channels and at least one of the one or more first channels according to the updated bitmap, where the updated bitmap is included in the one or more additional beacons. The operations of 1130 may be performed in accordance with examples as disclosed herein. In some examples, aspects of the operations of 1130 may be performed by a beacon manager 735 as described with reference to FIG. 7.

It should be noted that the methods described herein describe possible implementations, and that the operations and the steps may be rearranged or otherwise modified and that other implementations are possible. Furthermore, aspects from two or more of the methods may be combined.

The following provides an overview of aspects of the present disclosure:

Aspect 1: A method for wireless communications at an access point, comprising: identifying that a communications band includes one or more first channels of a first dynamic frequency selection type and one or more second channels of a second dynamic frequency selection type; performing a channel availability check procedure to determine if radar is being used on one of the one or more first channels; and transmitting, to a station during the channel availability check procedure, one or more beacons on at least one of the one or more second channels.

Aspect 2: The method of aspect 1, wherein the one or more first channels of the first dynamic frequency selection type are dynamic frequency selection channels, and the one or more second channels of the second dynamic frequency selection type are non-dynamic frequency selection channels.

Aspect 3: The method of any of aspects 1 through 2, further comprising: updating a bitmap during the channel availability check procedure to indicate that the one or more first channels are unavailable for transmission, wherein transmitting the one or more beacons is based at least in part on updating the bitmap.

Aspect 4: The method of aspect 3, further comprising: including the bitmap in the one or more beacons transmitted to the station during the channel availability check procedure.

Aspect 5: The method of any of aspects 3 through 4, further comprising: updating the bitmap, upon expiration of the channel availability check procedure, to indicate that at least one of the one or more first channels is available for transmission based at least in part on the channel availability check procedure; and transmitting, after expiration of the channel availability check procedure, one or more additional beacons on at least one of the one or more second channels and at least one of the one or more first channels according to the updated bitmap, wherein the updated bitmap is included in the one or more additional beacons.

Aspect 6: The method of any of aspects 3 through 5, further comprising: updating the bitmap, upon expiration of the channel availability check procedure, to indicate that at least one of the one or more first channels is unavailable for transmission based at least in part on the channel availability check procedure; initiating, after expiration of the channel availability check procedure, a second channel availability check procedure to determine if radar is being used on one or more additional first channels; and updating the bitmap, upon expiration of the second channel availability check procedure, to indicate that at least one of the one or more additional first channels is available or unavailable for transmission based at least in part on the second channel availability check procedure.

Aspect 7: The method of any of aspects 3 through 6, wherein including the bitmap in the one or more beacons further comprises: transmitting the bitmap in an extremely high throughput operation information element (IE) of the one or more beacons.

Aspect 8: The method of any of aspects 3 through 7, further comprising: including, in the one or more beacons and with the bitmap, an indication of a duration for which the bitmap is valid.

Aspect 9: The method of aspect 8, wherein the duration is indicated in units of time, transmission time intervals, or beacons.

Aspect 10: The method of any of aspects 3 through 9, further comprising: determining that the communications band is associated with a low-latency network, wherein updating the bitmap is based at least in part on the determining.

Aspect 11: The method of any of aspects 3 through 10, wherein each bit of the bitmap corresponds to one of the one or more first channels or one of the one or more second channels.

Aspect 12: The method of any of aspects 1 through 11, wherein the access point comprises a phone; and the station comprises a virtual reality device.

Aspect 13: The method of any of aspects 1 through 12, further comprising: monitoring, during the channel availability check procedure while simultaneously transmitting the one or more beacons, the one or more first channels for radar use; and determining whether detected radar on the one or more first channels satisfies a threshold amount of interference.

Aspect 14: An apparatus for wireless communications at an access point, comprising a processor; memory coupled with the processor; and instructions stored in the memory and executable by the processor to cause the apparatus to perform a method of any of aspects 1 through 13.

Aspect 15: An apparatus for wireless communications at an access point, comprising at least one means for performing a method of any of aspects 1 through 13.

Aspect 16: A non-transitory computer-readable medium storing code for wireless communications at an access point, the code comprising instructions executable by a processor to perform a method of any of aspects 1 through 13.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100, wireless communications system 200, and wireless communications system 201 of FIGS. 1, 2, and 3—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at an access point, comprising:
identifying that a communications band includes one or more first channels of a first dynamic frequency selection type and one or more second channels of a second dynamic frequency selection type;
performing a channel availability check procedure to determine if radar is being used on one of the one or more first channels; and
transmitting, to a station during the channel availability check procedure, one or more beacons on at least one of the one or more second channels.

2. The method of claim 1, wherein the one or more first channels of the first dynamic frequency selection type are dynamic frequency selection channels, and the one or more second channels of the second dynamic frequency selection type are non-dynamic frequency selection channels.

3. The method of claim 1, further comprising:
updating a bitmap during the channel availability check procedure to indicate that the one or more first channels are unavailable for transmission, wherein transmitting the one or more beacons is based at least in part on updating the bitmap.

4. The method of claim 3, further comprising:
including the bitmap in the one or more beacons transmitted to the station during the channel availability check procedure.

5. The method of claim 3, further comprising:
updating the bitmap, upon expiration of the channel availability check procedure, to indicate that at least one of the one or more first channels is available for transmission based at least in part on the channel availability check procedure; and
transmitting, after expiration of the channel availability check procedure, one or more additional beacons on at least one of the one or more second channels and at least one of the one or more first channels according to the updated bitmap, wherein the updated bitmap is included in the one or more additional beacons.

6. The method of claim 3, further comprising:
updating the bitmap, upon expiration of the channel availability check procedure, to indicate that at least one of the one or more first channels is unavailable for transmission based at least in part on the channel availability check procedure;
initiating, after expiration of the channel availability check procedure, a second channel availability check procedure to determine if radar is being used on one or more additional first channels; and
updating the bitmap, upon expiration of the second channel availability check procedure, to indicate that at least one of the one or more additional first channels is available or unavailable for transmission based at least in part on the second channel availability check procedure.

7. The method of claim 3, wherein including the bitmap in the one or more beacons further comprises:
transmitting the bitmap in an extremely high throughput operation information element (IE) of the one or more beacons.

8. The method of claim 3, further comprising:
including, in the one or more beacons and with the bitmap, an indication of a duration for which the bitmap is valid.

9. The method of claim 8, wherein the duration is indicated in units of time, transmission time intervals, or beacons.

10. The method of claim 3, further comprising:
determining that the communications band is associated with a low-latency network, wherein updating the bitmap is based at least in part on the determining.

11. The method of claim 3, wherein each bit of the bitmap corresponds to one of the one or more first channels or one of the one or more second channels.

12. The method of claim 1, wherein:
the access point comprises a phone; and
the station comprises a virtual reality device.

13. The method of claim 1, further comprising:
monitoring, during the channel availability check procedure while simultaneously transmitting the one or more beacons, the one or more first channels for radar use; and
determining whether detected radar on the one or more first channels satisfies a threshold amount of interference.

14. An apparatus for wireless communications at an access point, comprising:
a processor;
memory coupled with the processor; and
instructions stored in the memory and executable by the processor to cause the apparatus to:
identify that a communications band includes one or more first channels of a first dynamic frequency selection type and one or more second channels of a second dynamic frequency selection type;
perform a channel availability check procedure to determine if radar is being used on one of the one or more first channels; and
transmit, to a station during the channel availability check procedure, one or more beacons on at least one of the one or more second channels.

15. The apparatus of claim 14, wherein the one or more first channels of the first dynamic frequency selection type are dynamic frequency selection channels, and the one or more second channels of the second dynamic frequency selection type are non-dynamic frequency selection channels.

16. The apparatus of claim 14, wherein the instructions are further executable by the processor to cause the apparatus to:
update a bitmap during the channel availability check procedure to indicate that the one or more first channels are unavailable for transmission, wherein to transmit the one or more beacons, the instructions are further executable by the processor to cause the apparatus to transmit the one or more beacons based at least in part on updating the bitmap.

17. The apparatus of claim 16, wherein the instructions are further executable by the processor to cause the apparatus to:
include the bitmap in the one or more beacons transmitted to the station during the channel availability check procedure.

18. The apparatus of claim 16, wherein the instructions are further executable by the processor to cause the apparatus to:
update the bitmap, upon expiration of the channel availability check procedure, to indicate that at least one of the one or more first channels is available for transmission based at least in part on the channel availability check procedure; and
transmit, after expiration of the channel availability check procedure, one or more additional beacons on at least one of the one or more second channels and at least one of the one or more first channels according to the updated bitmap, wherein the updated bitmap is included in the one or more additional beacons.

19. The apparatus of claim 16, wherein the instructions are further executable by the processor to cause the apparatus to:
update the bitmap, upon expiration of the channel availability check procedure, to indicate that at least one of the one or more first channels is unavailable for transmission based at least in part on the channel availability check procedure;
initiate, after expiration of the channel availability check procedure, a second channel availability check procedure to determine if radar is being used on one or more additional first channels; and
update the bitmap, upon expiration of the second channel availability check procedure, to indicate that at least one of the one or more additional first channels is available or unavailable for transmission based at least in part on the second channel availability check procedure.

20. The apparatus of claim 16, wherein the instructions to include the bitmap in the one or more beacons are further executable by the processor to cause the apparatus to:
transmit the bitmap in an extremely high throughput operation information element (IE) of the one or more beacons.

21. The apparatus of claim 16, wherein the instructions are further executable by the processor to cause the apparatus to:
include, in the one or more beacons and with the bitmap, an indication of a duration for which the bitmap is valid.

22. The apparatus of claim 21, wherein:
the duration is indicated in units of time, transmission time intervals, or beacons.

23. The apparatus of claim 16, wherein the instructions are further executable by the processor to cause the apparatus to:
determine that the communications band is associated with a low-latency network, wherein updating the bitmap is based at least in part on the determining.

24. The apparatus of claim 16, wherein:
each bit of the bitmap corresponds to one of the one or more first channels or one of the one or more second channels.

25. The apparatus of claim 14, wherein:
the access point comprises a phone; and
the station comprises a virtual reality device.

26. The apparatus of claim 14, wherein the instructions are further executable by the processor to cause the apparatus to:
monitor, during the channel availability check procedure while simultaneously transmitting the one or more beacons, the one or more first channels for radar use; and
determine whether detected radar on the one or more first channels satisfies a threshold amount of interference.

27. An apparatus for wireless communications at an access point, comprising:
means for identifying that a communications band includes one or more first channels of a first dynamic frequency selection type and one or more second channels of a second dynamic frequency selection type;
means for performing a channel availability check procedure to determine if radar is being used on one of the one or more first channels; and
means for transmitting, to a station during the channel availability check procedure, one or more beacons on at least one of the one or more second channels.

28. The apparatus of claim 27, wherein the one or more first channels of the first dynamic frequency selection type are dynamic frequency selection channels, and the one or more second channels of the second dynamic frequency selection type are non-dynamic frequency selection channels.

29. The apparatus of claim 27, further comprising:
means for updating a bitmap during the channel availability check procedure to indicate that the one or more first channels are unavailable for transmission, wherein the means for transmitting the one or more beacons further comprise means for transmitting the one or more beacons based at least in part on updating the bitmap.

30. The apparatus of claim 29, further comprising:
means for including the bitmap in the one or more beacons transmitted to the station during the channel availability check procedure.

31. The apparatus of claim 29, further comprising:
means for updating the bitmap, upon expiration of the channel availability check procedure, to indicate that at least one of the one or more first channels is available for transmission based at least in part on the channel availability check procedure; and
means for transmitting, after expiration of the channel availability check procedure, one or more additional beacons on at least one of the one or more second channels and at least one of the one or more first channels according to the updated bitmap, wherein the updated bitmap is included in the one or more additional beacons.

32. The apparatus of claim 29, further comprising:
means for updating the bitmap, upon expiration of the channel availability check procedure, to indicate that at least one of the one or more first channels is unavailable for transmission based at least in part on the channel availability check procedure;
means for initiating, after expiration of the channel availability check procedure, a second channel availability check procedure to determine if radar is being used on one or more additional first channels; and
means for updating the bitmap, upon expiration of the second channel availability check procedure, to indicate that at least one of the one or more additional first channels is available or unavailable for transmission based at least in part on the second channel availability check procedure.

33. The apparatus of claim 29, wherein the means for including the bitmap in the one or more beacons further comprise:
means for transmitting the bitmap in an extremely high throughput operation information element (IE) of the one or more beacons.

34. The apparatus of claim 29, further comprising:
means for including, in the one or more beacons and with the bitmap, an indication of a duration for which the bitmap is valid.

35. The apparatus of claim 34, wherein:
the duration is indicated in units of time, transmission time intervals, or beacons.

36. The apparatus of claim 29, further comprising:
means for determining that the communications band is associated with a low-latency network, wherein updating the bitmap is based at least in part on the determining.

37. The apparatus of claim 29, wherein:
each bit of the bitmap corresponds to one of the one or more first channels or one of the one or more second channels.

38. The apparatus of claim 27, wherein:
the access point comprises a phone; and
the station comprises a virtual reality device.

39. The apparatus of claim 27, further comprising:
means for monitoring, during the channel availability check procedure while simultaneously transmitting the one or more beacons, the one or more first channels for radar use; and
means for determining whether detected radar on the one or more first channels satisfies a threshold amount of interference.

40. A non-transitory computer-readable medium storing code for wireless communications at an access point, the code comprising instructions executable by a processor to:
identify that a communications band includes one or more first channels of a first dynamic frequency selection type and one or more second channels of a second dynamic frequency selection type;
perform a channel availability check procedure to determine if radar is being used on one of the one or more first channels; and
transmit, to a station during the channel availability check procedure, one or more beacons on at least one of the one or more second channels.
